(19) United States
(12) Patent Application Publication
(10) Pub. No.: US 2002/0163229 A1
(43) Pub. Date: Nov. 7, 2002

(54) Chair

(76) Inventor: Uwe Schefthaler, Taufkirchen/Vils (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/805,738

(22) Filed: Mar. 13, 2001

(51) Int. Cl. A47C 1/02; A61G 15/00

(52) U.S. Cl. 297/68; 180/65.1

(57) ABSTRACT

The invention relates to a movable chair, in particular for the living area, having at least one roller which can be driven by an electric motor, with the chair preferably being an easy chair or armchair.

The invention relates to a chair, in particular for the living area.

Particularly the elderly or those with a walking disability can frequently only get around the rooms of their own homes with difficulty, whereby the quality of life of these people is impaired.

The problem (object) underlying the invention is to increase the quality of life of in particular the elderly and/or those with a walking disability.

This object is satisfied by the features of claim 1 and in particular by a movable chair being provided which has at least one roller which can be driven by an electric motor. The chair is preferably an easy chair or an armchair.

The elderly and/or those with a walking disability can move around the rooms of their own homes without difficulty with such a movable chair. Furthermore, such a movable chair can be moved easily by people with weak physical powers with the aid of the electric drive; this is particularly of advantage with heavy chairs. The movable chairs in accordance with the invention are preferably relaxation, massage and/or TV chairs such as are usual in living rooms. Generally, however, such chairs can also be made movable in accordance with the invention which are available as seats in private or public institutions. The chairs in accordance with the invention can be used, for example, in old people's homes or generally in the care industry, for example in hospitals.

The roller or rollers of the movable chair can be of any form desired and can, for example, be formed as wheels or castors. Rollers of different kinds can be provided at one chair. For example, one or more wheel-like rollers can be drivable by the electric motor and one or more castors can be provided as steering rollers.

In accordance with a preferred embodiment of the invention, one roller and one electric motor each are integrated into a drive module mountable to the chair as a unit. The mounting of the drive to the chair is substantially simplified by this. It is in particular possible to retrofit existing model series of relaxation, massage and/or TV chairs at low cost and with low effort and to subsequently provide them with a drive.

It is preferred if each drive module comprises a transmission arranged between the electric motor and a driving axle of the roller, with the transmissions each being directly connected to the rollers and one electric motor each and one transmission each being integrated into a compact drive unit. Particularly compact, easy-to-operate and easily mountable drive modules are provided in this manner which comprise in each case an electric motor, a transmission and a roller.

The transmissions can, for example, be pushed onto the driving axles of the rollers. It is vice versa also possible to push the rollers in each case onto a driving axle or shaft of the transmissions.

Each drive module moreover preferably comprises a carrier structure to which the roller and the drive unit comprising the electric motor and the transmission are fitted and via which the drive module can be fastened to the chair. The drive module can be assembled separately from the chair and prepared for mounting in this manner, for which then only the carrier structure has to be fastened to the chair in order to attach the whole drive module to the chair.

It is preferred here if the carrier structures are each connectable to a side part and/or a fitting of the chair, in particular screwable thereto. The arrangement of the drive modules in the region of the side parts of the chair has the advantage that no components have to be arranged in the backrest region of the chair for the drive. This is in particular of advantage with massage chairs in which massage devices are integrated in the backrest part.

The drive modules are preferably each formed and attachable to the chair in such a way that the drive modules are each integrated in a side part of the chair and/or covered by cushioning of the chair. The visual appearance of the chair is thus in no way impaired by the drive modules.

With chairs, for example easy chairs or armchairs, which have a separate underframe in which, for example, fittings and other mechanical and/or electromechanical devices are integrated, it is preferred for the drive module(s) also to be integrated in such an underframe. Control devices and supply devices for the drive modules can also be arranged in the region of the underframe.

In accordance with a preferred embodiment of the invention, a control unit is provided via which, when a plurality of drivable rollers are provided, the electric motors can then be operated independently of one another. The possibility of controlling the rollers independently of one another allows the rollers to be driven with different rotating speeds. As with tracked vehicles, in which a change in direction is achieved by tracks running at different speeds, the movable chair in accordance with the invention can be steered by driving the rollers with different rotating speeds. It is in particular possible to operate the electric motors with different polarities so that one roller turns forwards and the other roller backwards, This drive possibility also used with tracked vehicles allows the movable chair in accordance with the invention to be turned on the spot and thus to achieve a change in direction quickly and simply even in tight spaces. The chair can in particular be turned in very tight spaces in this way, i.e. turned through 180°.

In accordance with a further preferred embodiment of the invention, the control unit is provided with an automatic start and/or stop function with which the rotating speeds of the rollers can automatically be gradually brought to the value desired by the user with a preset time lag in the event of a user-initiated speed change. An irritating, jolting start can be avoided by such a function, which is also known as a “soft start” function with respect to starting.

In a preferred embodiment of the chair in accordance with the invention, two rollers are provided which are arranged in one of the rear corner regions of the chair respectively. Conventional furniture castors are provided at the front corner regions in this case, for example.

It is also possible to arrange the rollers, i.e. the drive modules, further forward at the side parts, for example approximately at the centre and then to provide a supporting roller or castor at each corner region to support the chair.

The rollers, i.e. the drive modules, can moreover also be arranged further inwardly and thus not in the region of the side parts.

It is generally also possible to arrange one drivable roller each in each of the four corner regions of the chair. If, in accordance with the preferred variant, each of these rollers is provided with an electric motor associated with it, a highly manoeuvrable chair can be provided by an individual control of the individual electric motors. A further advantage of such a “four-wheel drive” is the ability to overcome obstacles such as thresholds, carpet edges and deep pile carpets since no freely turnable furniture rollers, which easily tend to block, are required.

Generally, in accordance with the invention, with a chair drivable, for example, by two or four rollers, at least two rollers in each case can be driven via a common electric motor, with the rollers having a differential gear positioned before them and with the rollers being formed so that they can be steered to change direction. It is, however, also possible to provide non-steerable rollers always oriented on moving straight forwards and an infinitely adjustable differential gear to change direction.

In accordance with a further version of the invention, only one single drivable roller can be provided which is, for example, arranged centrally in the central or rear region of the chair and designed to be steerable. An extremely manoeuvrable chair is also provided with such an arrangement, with a change of direction being carried out in very tight space by turning the roller transversely.

In accordance with the invention, the rollers can principally be arranged at any position on the chair, with either only one single roller being drivable or with a plurality, in particular two or four, rollers being provided with a drive.

In accordance with a variant of the invention, one single central roller is provided, i.e. a drivable roller arranged centrally with respect to both the longitudinal direction and the transverse direction.

In accordance with a further possible variant, the chair has four rollers which are each arranged in a corner region of the chair, with two rollers diagonally opposite one another, e.g. the front right roller and the rear left roller, being provided with a drive each.

It is furthermore also possible in accordance with the invention to drive exclusively one or a plurality of rollers arranged in the front region of the chair. A purely front-wheel drive of the chair is realised in this manner, with which obstacles such as carpet edges or thresholds can be overcome without problem.

The rollers can be fastened, for example, to the side parts of the chair, and indeed either directly or via a suitable carrier structure. It is alternatively possible to attach the rollers to a fitting of the chair, for example to a fitting for the adjustment of a footrest or other components of the chair.

In a further embodiment of the invention, the or each drivable roller is provided with a spring suspension which ensures that the respective roller remains in permanent contact with the floor. Optimum floor adhesion of the movable chair is provided in this manner,

A further preferred embodiment proposes providing a slip clutch respectively between a drive motor and the driving roller, said slip clutch serving as an overload and transport protection. Damage to the drive unit, in particular to the motor, or, for example, when the chair is being moved by the user by hand, can be reliably avoided in this manner.

While it is generally possible in accordance with the invention to drive driving rollers arranged on opposite sides with a different direction of rotation to take curves or to turn the chair on the spot, the driving rollers can alternatively also always be driven with the same direction of rotation, but at different speeds. That is, the driving rollers turn in the same direction to take curves, but at different speeds, with a driving roller being stationary in extreme cases, for example the or each left driving roller, when taking a sharp left curve,

Further embodiments of the invention are given in the dependent claims of the description and of the drawing. The invention is described in the following by way of example with reference to the drawing. There are shown:

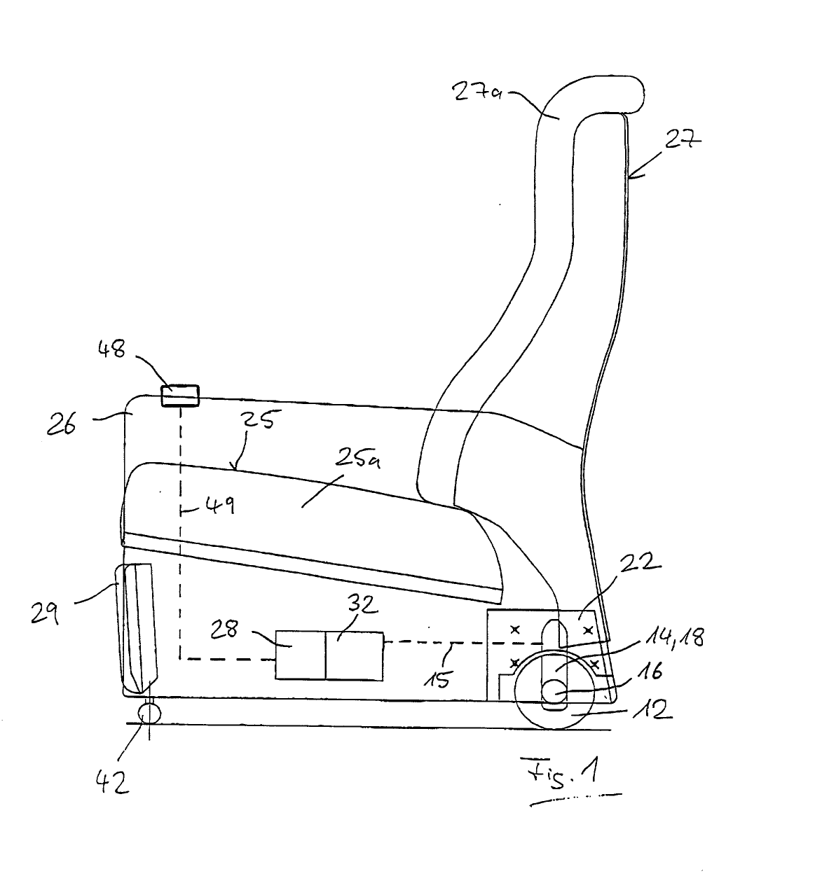

FIG. 1 a schematic side view of a chair in accordance with an embodiment of the invention;

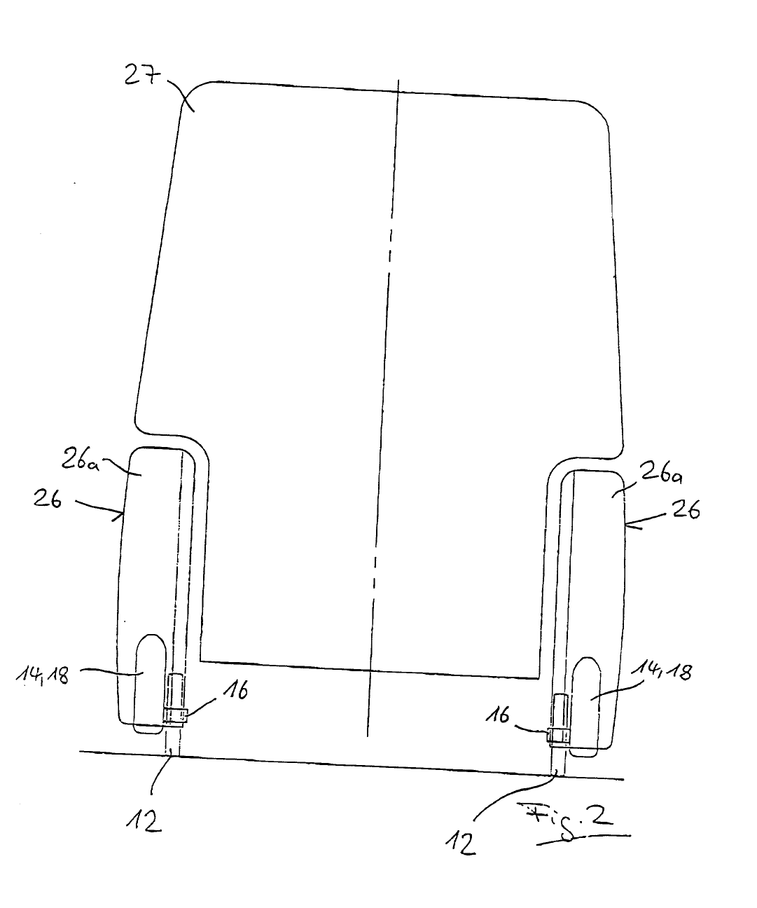

FIG. 2 a rear view of the chair of FIG. 1; and

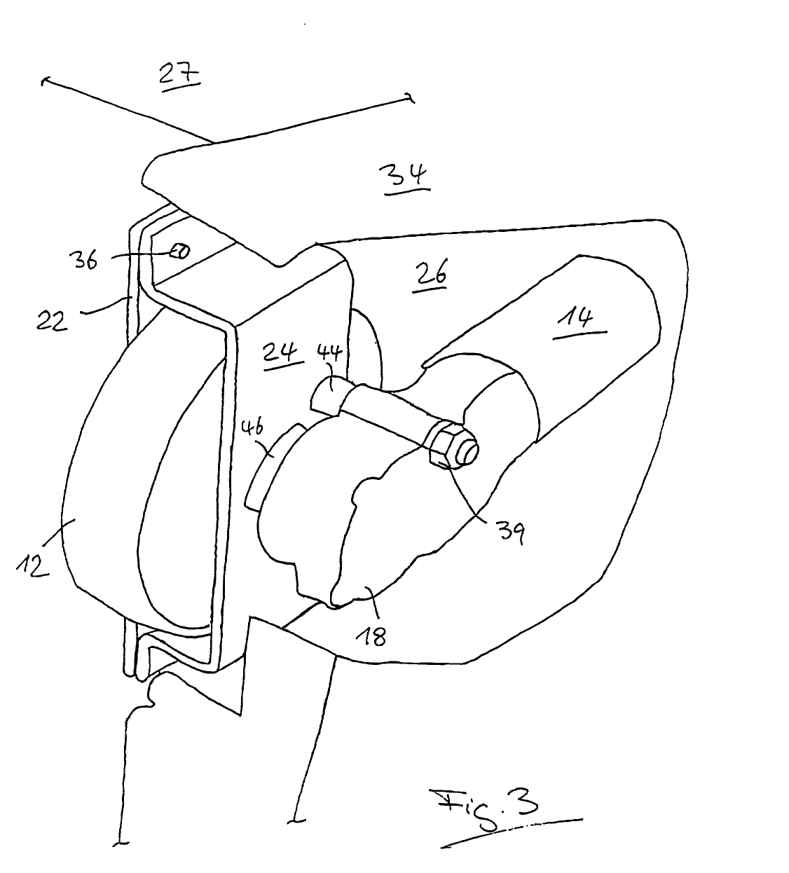

FIG. 3 a schematic view of a drive module in accordance with the invention mounted to a chair.

In the chair in accordance with the invention of FIG. 1, the chair is a movable armchair having a seat part 25, a backrest part 27 and two side parts 26. A backrest cushioning 27a and a seat cushioning 25a can be seen in this representation. The armchair furthermore comprises a pivotable footrest 29, with all devices such as fittings to adjust the footrest 29 and other components of the armchair in FIG. 1 not being shown for reasons of simplicity.

The armchair in question can be a functional piece of furniture which is equipped with different functions such as massage devices, heating devices, etc.

Whereas standard furniture castors 42 are arranged in the front corner regions 42 of the armchair, the armchair is provided with a drive module in each of the rear corner regions, said drive module substantially comprising a drive unit 14, 18 and a wheel or a roller 12 which can be driven by means of the drive unit 14, 18. The drive unit 14, 18 comprises an electric motor and a transmission, with the transmission being set directly on the driving axle 16 of the roller 12.

A possible design of the drive module is described in the following in connection with FIG. 3.

The drive module further comprises a carrier structure of which a board-like carrier member 22 can be seen in FIG. 1. The drive module is fastened to the armchair via the board-like carrier member 22 which is screwed to the side part 26 of the armchair. The drive unit 14, 18 is fastened to a further carrier member which is not shown in FIG. 1 and is in turn connected to the carrier member 22. The assembled drive module can thus be mounted as a unit simply by screwing the board-like carrier member 22 to the side part 26 on the armchair.

The electric motor 14 is connected to a rechargeable battery unit 32 via a supply line 15 only indicated by a broken line in FIG. 1, said rechargeable battery unit 32 being connected to a control unit 28. The rechargeable battery unit 32 and the control unit 28 are arranged in a hollow space of the armchair under the seat part 25.

A control element 48 shown only schematically in FIG. 1 is attached to the side part 26 and can be integrated, for example, in the arm of the chair. The control element 48 is connected to the control unit 28 via a line 49 shown by a broken line in FIG. 1. The control element 48 can, for example, be a separate device for moving operation which is formed, for example as a control level in the form of a so-called joystick or as a keypad provided with direction keys. It is also possible to integrate the control for moving operation in an existing control element∫via which other functions of the armchair, such as a massage device, can be actuated. The control parts for moving operation can be provided in a separate module which can be coupled to the existing control element by, for example, being plugged to the existing control element,

The electric motors 14 of the drive modules can be controlled independently of one another via the control element 48 and the control unit 28. Straight-ahead movement operation in a forward direction or a backward direction can be realised, any tight or wide curves can be taken with the armchair and the armchair can be turned on the spot—as is described in the introduction to the description—in dependence on the size and the polarity of the voltages applied to the electric motors 14. If steerable rollers are used, then the control of the steering devices provided to steer the rollers is also carried out via the control unit 28.

In particular the integration of the drive modules in the side parts 26 of the armchair can be seen from the rear view of FIG. 2. The drive units, which each comprise an electric motor 14 and a transmission 18, are respectively arranged in the region of the cushionings 26a of the side parts 26 and thus hidden for an observer by the cushionings 26a. The external appearance of the armchair is thus not altered by the drive modules.

The rear right corner region of an armchair is shown in FIG. 3, with a drive module of identical construction being arranged at the rear left corner region (not shown) of the armchair. The right-hand side part 26 made of wood and a structural member 34 made of plastic, at which the material covering and/or the cushioning of the side part 26 are fastened, can be seen. Furthermore, the backrest part 27 of the armchair is indicted in FIG. 3.

It can be seen from FIG. 3 that the drive modules in accordance with the invention are very compact sub-assemblies.

The board-like carrier member 22 of the carrier structure is screwed to the side part 26 of the armchair from the inside. In turn, a U-shaped, bent carrier member 24 is screwed to the board-like carrier member 22, with the screw connection being indicated in FIG. 3 by the shaft of one of the connecting screws 36.

A roller or wheel 12 is arranged in the intermediate space formed by the two carrier members 22, 24 and its driving axle, which is not shown in FIG. 3, is journalled in corresponding recesses of the carrier members 22, 24 so that the roller 12 is supported at both sides.

The transmission 18 of the drive unit is screwed at least at one point to a cylindrical lug 44 of the U-shaped carrier member 24 via a screw 39. Furthermore, the transmission 18 is pushed directly onto the driving axle of the roller 12 and is supported at a cylindrical lug 46 of the carrier member 24 coaxial to the driving axle. The cylindrical electric motor 14 is set directly on the transmission 18 so that the transmission 18 and the electric motor 14 form a very compact drive unit.

The electric motor 14 is connected to a rechargeable batter unit appropriately arranged under the seat part of the armchair via supply lines not shown in FIG. 3.

Reference numeral list

| | |
|---|---|
| 12 | roller |
| 14 | electric motor |
| 15 | supply line |
| 16 | driving axle |
| 18 | transmission |
| 22 | carrier member |
| 24 | carrier member |
| 25 | seat part |
| 25a | cushioning |
| 26 | side part |
| 26a | cushioning |
| 27 | backrest part |
| 27a | cushioning |
| 28 | control unit |
| 29 | footrest |
| 32 | rechargeable battery unit |
| 34 | structural member |
| 36 | screw |
| 39 | screw |
| 42 | front roller |
| 44 | lug |
| 46 | lug |
| 48 | control element |
| 49 | line |

1. A movable chair, in particular for the living area, having at least one roller (12) which can be driven by an electric motor (14), with the chair preferably being an easy chair or armchair.

2. A chair in accordance with claim 1, characterized in that two rollers (12) are provided which can be driven by at least one electric motor (14), with an electric motor (14) preferably being associated with each roller (12).

3. A chair in accordance with claim 1, characterized in that one roller (12) each and one electric motor (14) each are assembled to form a drive module which can be mounted to the chair as a unit.

4. A chair in accordance with claim 1, characterized in that the drive modules are respectively integrated in a side part (26) of the chair and/or are covered by a cushioning of the chair.

5. A chair in accordance with claim 1, characterized in that each drive module is integrated in an underframe of the chair.

6. A chair in accordance with claim 1, characterized in that each drive module comprises a transmission (18) arranged between the electric motor (14) and a driving axle (16) of the roller (12), with the transmission (18) preferably being directly connected to the roller (12).

7. A chair in accordance with claim 6, characterized in that the transmissions (18) are each pushed onto the driving axles (16) of the rollers (12).

8. A chair in accordance with claim 1, characterized in that one electric motor (14) each and one transmission (18) each are assembled to form a compact drive unit.

9. A chair in accordance with claim 1, characterized in that each drive module comprises a carrier structure (22, 24) to which the roller (12) and the electric motor (14), in particular a drive unit comprising the electric motor (14) and a transmission (18), are attached and via which the drive module can be fastened to the chair.

10. A chair in accordance with claim 9, characterized in that the carrier structures each comprise a board-like carrier member (22) and a U-shaped carrier member (24), with the roller (12) being arranged between the two carrier members (22, 24).

11. A chair in accordance with claim 9, characterized in that drive units comprising one electric motor (14) each and one transmission (18) each are connected, in particular screwed, to the carrier structure (22, 24) via the transmission (18) in each case.

12. A chair in accordance with claim 9, characterized in that the carrier structures (22, 24) can be connected, in particular screwed, in each case to a side part (26) and/or to a fitting of the chair.

13. A chair in accordance with claim 9, characterized in that the carrier structures are respectively connected to the chair via a board-like carrier element (22) and to a drive unit comprising the electric motor (14) and a transmission (18) via a U-shaped carrier element (24).

14. A chair in accordance with claim 1, characterized in that a control unit (28) is provided which can be controlled by a person sitting in the chair via a control element (48) and via which the electric motors (14) and/or steering devices for the rollers (12) can be driven independently of one another.

15. A chair in accordance with claim 1, characterized in that the rollers (12), in particular the non-steerable rollers (12), can be driven at different speeds and/or in opposite directions to change the direction of movement.

16. A chair in accordance with claim 1, characterized in that a control unit (28) is provided with an automatic start and/or stop function, through which the speeds of the rollers (12) can automatically be gradually brought to the value desired by the user with a preset time lag in the event of a user-initiated speed change.

17. A chair in accordance with claim 1, characterized in that four drivable rollers are provided, each of which is arranged in a corner region of the chair.

18. A chair in accordance with claim 1, characterized in that two drivable rollers are provided which are arranged in diagonally opposite corner regions of the chair.

19. A chair in accordance with claim 1, characterized in that exactly one drivable and steerable roller is provided which is arranged centrally and in particular in the rear or central region of the chair.

20. A chair in accordance with claim 1, characterized in that at least two rollers can be driven via a common electric motor, with a differential gear being positioned before the rollers.

21. A chair in accordance with claim 20, characterized in that the rollers are unsteerable and in that the differential gear is in particular infinitely adjustable to change direction.

22. A chair in accordance with claim 1, characterized in that a battery unit and/or a rechargeable battery unit (32) is/are integrated in the chair for the power supply.

23. A chair in accordance with claim 1, characterized in that it can be connected to an electric power supply for the supply of power.
